(19) United States
(12) Patent Application Publication
(10) Pub. No.: US 2014/0006512 A1
(43) Pub. Date: Jan. 2, 2014

(54) Methods for Exchanging User Profile, Profile Mediator Device, Agents, Computer Programs and Computer Program Products

(71) Applicants: Vincent Huang, Sollentuna (SE); Yi Cheng, Sundbyberg (SE); Mona Matti, Nacka (SE)

(72) Inventors: Vincent Huang, Sollentuna (SE); Yi Cheng, Sundbyberg (SE); Mona Matti, Nacka (SE)

(73) Assignee: TELEFONAKTIEBOLAGET L M ERICSSON (PUBL), Stockholm (SE)

(21) Appl. No.: 14/003,096

(22) PCT Filed: Mar. 22, 2011
(86) PCT No.: PCT/SE2011/050317

§ 371 Date: Sep. 4, 2013

(51) Int. Cl. H04L 29/08

(52) U.S. Cl. CPC H04L 67/306
USPC 709/204

(57) ABSTRACT

The invention relates to a method 20 performed in a profile mediator device 5 for exchanging user profile UP1 of a user between a first service provider SP1 having a first user profile UP1 for the user, and a second service provider SP2. The method 20 comprises: receiving 21 from the second service provider SP2 a request for the user profile UP1; retrieving 22 a policy corresponding to the user profile UP1; generating 23 a request identification Q12 for the request; and sending 24 the request identification Q12 to the second service provider SP2, the request identification Q12 enabling the first service provider SP1 to exchange the user profile UP1 with the second service provider SP2 in accordance with the policy. The invention also relates to a profile mediator device, agents, computer programs and computer program products.

### FIELD OF THE INVENTION

The invention relates to devices and methods for enabling exchange of user profiles between a first and a second service provider.

### BACKGROUND OF THE INVENTION

With an ever increasing amount of web-based services and vast amount of available information, an increasing number of service providers want to provide context-aware and customized services to end users. Context information about the users can come from different sources, e.g. services which the users are utilizing. Sharing of user information among service providers rely on that the user approves the sharing of information from one service provider, with which the user has an agreement, with another service provider.

Today, there is no standard solution for exchanging user sensitive information among different service providers. Each service provider has its own solution and the user needs to sign contracts with each service provider individually about the usage of personal information.

There is no existing infrastructure to support handling of user profiles and private information. It is therefore difficult to provide customized services without intruding on the privacy of the user.

In view of the above, it would be desirable to facilitate the exchange of personal information for context-aware services, without compromising on the integrity of the user.

### SUMMARY OF THE INVENTION

It is an object of the invention to facilitate the handling of user profiles and private information for enabling the provision of customized and context-aware services to the user, while maintaining the integrity of the user.

In a first aspect of the invention, the object is achieved by a method in a profile mediator device. The method is performed in a profile mediator device for exchanging user profile of a user between a first service provider having a first user profile for the user, and a second service provider. The method comprises: receiving from the second service provider a request for the user profile; retrieving a policy corresponding to the user profile; generating a request identification for the request, and sending the request identification to the second service provider. The request identification enables the first service provider to exchange the user profile with the second service provider in accordance with the policy.

By means of the profile mediator device, there is no need for each service provider to have advance knowledge about user identification and the user's integrity is maintained. The profile mediator device has to verify all user profile information that is being shared between the service providers. The invention thus provides a common framework to support the sharing of user information among service providers and still protect the user privacy.

In an embodiment, the method comprises the step of receiving, from the first service provider, a request for a processing algorithm corresponding to the request identification, the processing algorithm comprising filtering user information in accordance with the policy, thus obtaining a filtered user profile.

In the above embodiment, the processing algorithm may further comprise encryption keys enabling the first service provider to encrypt the filtered user profile.

In an embodiment, the method comprises the further step of, upon receiving from the second service provider the request for the user profile, mapping a user identification received with the request onto services provided to the user by first service provider.

In an embodiment, step of retrieving the policy corresponding to the user profile, further comprises the sub-step of evaluating the user profile against the policy.

In an embodiment, the step of retrieving a policy comprises retrieving the policy from a policy server, the policy comprising policy rules set by the user.

In an embodiment, the exchanged user profile is an adapted version of the user profile of the first service provider, comprising user information conforming to the policy.

In an embodiment, the request for the user profile is received from a second trusted agent, such as a software agent, of the second service provider.

In a second aspect of the invention, the object is achieved by a profile mediator device for enabling exchange of a user profile between a first service provider and a second service provider. The profile mediator device comprises a controller arranged to: receive, using an input/output device, from the second service provider a request for the user profile; retrieve, using the input/output device, a policy corresponding to the user profile; generate a request identification for the request; and send, using the input/output device, the request identification to the second service provider, the request identification enabling the first service provider to exchange the user profile with the second service provider.

In a third aspect of the invention, the object is achieved by a computer program for a profile mediator device for enabling exchange of a user profile between a first service provider and a second service provider. The computer program comprises computer program code which, when run on the profile mediator device, causes the profile mediator device to perform the steps of: receiving from the second service provider a request for the user profile; retrieving a policy corresponding to the user profile; generating a request identification for the request; and sending the request identification to the second service provider, the request identification enabling the first service provider to exchange the user profile with the second service provider.

In an embodiment, a computer program product is provided comprising a computer program as above and a computer readable means on which the computer program is stored.

In a fourth aspect of the invention, the object is achieved by a method performed in an agent of a second service provider for exchanging a user profile between a first service provider and the second service provider, the method comprising: receiving a user request to use a service provided by the second service provider; receiving, from the user, a user profile identification confirming consensus to share with the second service provider a user profile from the first service provider in accordance with a policy; requesting from a profile mediator device authorization to get the user profile of the first service provider identified by the user profile identification; receiving from the profile mediator device a request identification, the request identification enabling the first service provider to exchange the user profile with the second service provider.

In an embodiment, the method comprises the further step of transmitting to the first service provider a request for obtaining the user profile, the request comprising the request identification.

In an embodiment, the method comprises the steps of receiving in response from the first service provider a filtering of user profile encrypted and decrypting the filtering of user profile.

In an embodiment, the decryption is performed by means of a public key or by means of a symmetric key received from the profile mediator device.

In an embodiment, the filtering of user profile has been processed by a processing algorithm corresponding to the request identification, the processing algorithm comprising filtering user information in accordance with the policy, thus obtaining a filtered user profile.

In an embodiment, the method comprises the further step of, upon receiving the user request to use a service, checking authorization of the user to use services of the second service provider.

In an embodiment, the step of receiving consensus to share a user profile is received as a response to an inquiry sent to the user about user preferences.

In a fifth aspect of the invention, the object is achieved by agent for a second service provider for exchanging a user profile between a first service provider and the second service provider. The agent comprises a controller arranged to: receive, by means of an input/out device, a user request to use a service provided by the second service provider; receive, by means of the input/out device, from the user, a user profile identification confirming consensus to share with the second service provider a user profile from the first service provider in accordance with a policy; requesting from a profile mediator device, by means of the input/out device, authorization to get the user profile of the first service provider identified by the user profile identification; and receiving from the profile mediator device, by means of the input/out device, a request identification, the request identification enabling the first service provider to exchange the user profile with the second service provider.

In a sixth aspect of the invention, the object is achieved by a computer program for an agent for exchanging a user profile between a first service provider and a second service provider, the computer program comprising computer program code which, when run on the agent, causes the agent to perform the steps of: receiving a user request to use a service provided by the second service provider; receiving, from the user, a user identification confirming consensus to share with the second service provider a user profile of the first service provider; requesting from a profile mediator device authorization to get the user profile of the first service provider identified by the user identification; and receiving from the profile mediator device a request identification, the request identification enabling the first service provider to exchange the user profile with the second service provider.

In an embodiment, a computer program product is provided comprising a computer program as above and a computer readable means on which the computer program is stored.

In a seventh aspect of the invention, the object is achieved by a method performed in an agent of a first service provider for exchanging a filtering of user profile between the first service provider and a second service provider. The method comprises: receiving from the second service provider a request for obtaining the user profile, the request comprising a request identification; transmitting to a profile mediator device the request identification, and receiving a processing algorithm corresponding to the request identification, the processing algorithm comprising filtering user information in accordance with a policy, thus obtaining a filtered user profile.

In an embodiment, the method comprises the further step of creating the filtered user profile in accordance with the processing algorithm and encrypting the filtered user profile.

In an embodiment, the method comprises the further step of transmitting to the second service provider the encrypted filtered user profile.

In an eight aspect of the invention, the object is achieved by agent for a first service provider for exchanging a filtering of user profile between the first service provider and a second service provider. The agent comprises a controller arranged to: receive, by means of an input/output device, from the second service provider a request for obtaining the user profile, the request comprising a request identification; transmitting, by means of the input/output device, to a profile mediator device the request identification; and receiving, by means of the input/output device, a processing algorithm corresponding to the request identification, the processing algorithm comprising filtering user information in accordance with a policy, thus obtaining a filtered user profile.

In an ninth aspect of the invention, the object is achieved by a computer program for an agent for exchanging a user profile between a first service provider and a second service provider, the computer program comprising computer program code which, when run on the agent, causes the agent to perform the steps of: receive from the second service provider a request for obtaining the user profile, the request comprising a request identification; transmit to a profile mediator device the request identification; and receive a processing algorithm corresponding to the request identification, the processing algorithm comprising filtering user information in accordance with a policy, thus obtaining a filtered user profile.

In an embodiment, a computer program product is provided comprising a computer program as above and a computer readable means on which the computer program is stored.

Further features and advantages thereof will become clear upon reading the following detailed description and the accompanying drawings.

### BRIEF DESCRIPTION OF THE DRAWINGS

FIG. 1 illustrates schematically an environment in which embodiments of the invention may be implemented.

FIG. 2 illustrates a part of a user profile model.

FIG. 3 illustrates filtering of user profile information of the user profile model of FIG. 2.

FIG. 4 is a first sequence diagram illustrating exchange of user profiles.

FIG. 5 is a second sequence diagram illustrating exchange of user profiles.

FIG. 6 is a flow chart illustrating a method performed in a profile mediator device.

FIG. 7 is a flow chart illustrating an embodiment of the method illustrated in FIG. 6.

FIG. 8 is a flow chart illustrating an embodiment of the method illustrated in FIG. 6.

FIG. 9 illustrates a profile mediator device.

FIG. 10 is a flow chart illustrating a method performed in an agent of a second service provider for exchanging user profile.

FIG. 11 is a flow chart illustrating an embodiment of the method illustrated in FIG. 10.

FIG. 12 is a flow chart illustrating a method performed in an agent of a first service provider for exchanging user profile.

FIG. 13 illustrates an agent for exchanging user profiles.

### DETAILED DESCRIPTION OF EMBODIMENTS

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail. Like numbers refer to like elements throughout the description.

Briefly, in different aspects, the invention provides methods and devices for secure sharing of personal information among service providers in a decentralized distributed deployment.

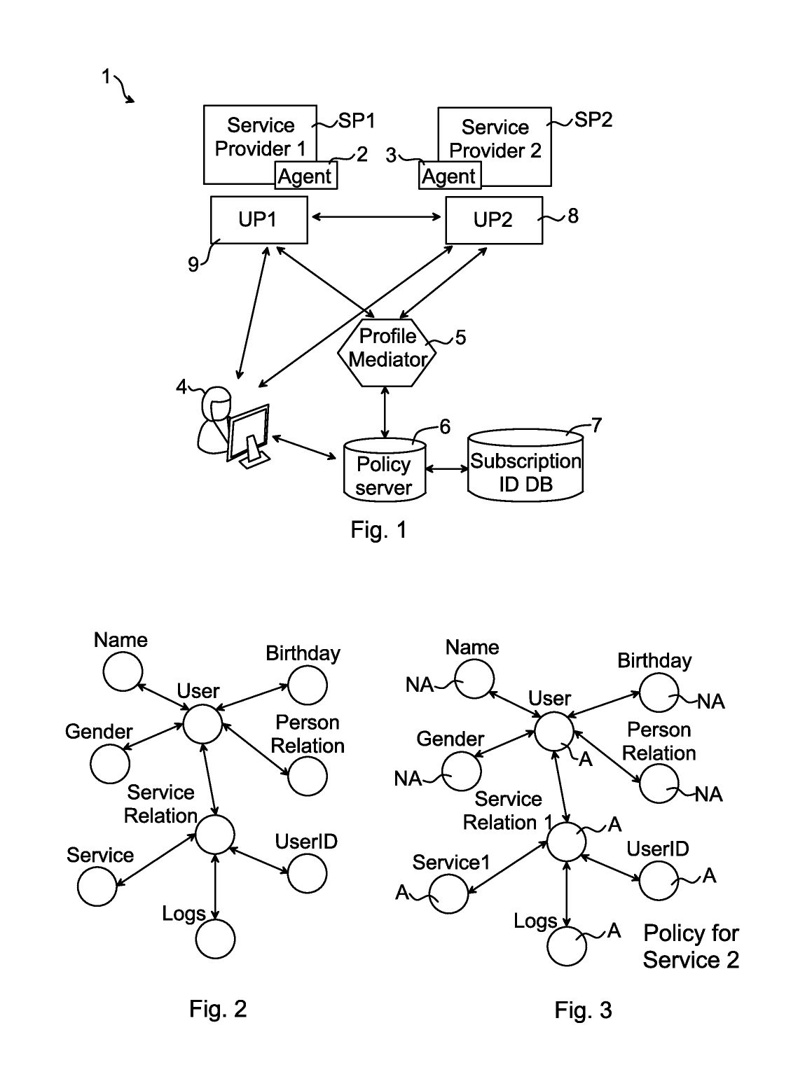

FIG. 1 illustrates schematically an environment in which embodiments of the invention may be implemented. In particular, a user profile access management system 1 is illustrated, in the following denoted system 1. The system 1 comprises a first provider SP1 and a second service provider SP2 from which a user 4 obtains or wants to obtain services. The user 4 may for example have an agreement with the first service provider SP1, e.g. user 4 has a subscription for using services from the first service provider SP1. The user 4 later wants to obtain services also from the second service provider SP2 and initiates contact. The first service provider SP1 already has a user profile UP1 relating to the user 4. The second service provider SP2, however, may not have such user profile, but wants to obtain as much information about the user 4 as possible in order to provide best possible service, e.g. by customizing the services in accordance with the user's 4 preferences. The second service provider SP2 thus wants a user profile UP2 relating to the user 4 and comprising as much information as possible. Initially the service provider SP2 may for example check with subscription data base or the like for ensuring that the user 4 is authorized to use the service. Once having confirmed such authorization, the second service provider SP2 asks the user 4 about her profile and/or preferences.

The system 1 comprises a policy server 6, which is a secure server handling policies that are created in accordance with user's consent and input.

One assumption for the system 1 is that there is a common user profile model enabling all service providers to understand what information they can provide and what information they need. A common user profile can use known ontologies, such as for example Friend of a Friend (FOAF) or Semantically-Interlinked Online Communities (SIOC).

FIG. 2 illustrates a part of a user profile model. As an example, the user profile UP1 of the first service provider SP1 may comprise information such as name, birthday, gender, person relation (e.g. married) of user, and service relation to the first service provider SP1, which services she uses, a log over user activities, and user identification (in the following denoted user ID).

The user 4 can decide what information of the user profile UP1 he wants to share with the second service provider SP2. FIG. 3 illustrates filtering of user profile information of the user profile model of FIG. 2. For example, the user 4 has decided that her name, gender, birthday and personal relation are not to be shared with the second service provider SP2. This user information is not allowed (denoted NA in the FIG. 3) for sharing. The service relation to the first service provider SP1, which services she uses, a log over her activities, and her user ID are however allowed to be shared (denoted A in the FIG. 3). The user profile UP1 of the first service provider SP1 is filtered, and information is only shared with the consent of the user 4.

It is noted that the user 4 can have different user IDs with different service providers. A service provider is not allowed to know the user IDs of other service providers. This information is stored in the policy server 6.

It is further noted that the above given types of user information are only examples for illustration. There are numerous other types of user information that can be used.

Now having described user profiles, we return to FIG. 1. The user 4 can thus specify, in the policy server 6, what user information can be used for each service provider and possibly also a time period during which the information can be used.

The system 1 further comprises a profile mediator device 5. The profile mediator device 5 is arranged to take care of all trusted communication within the system 1, comprising query identification, user service specific identities and policies without the need of advance knowledge about user identification in the respective service provider SP1, SP2. The profile mediator device 5 is arranged to communicate with trusted agents 2, 3 in each service provider SP1, SP2. The profile meditator device 5 ensures that the exchanged user information conforms to policies specified by the users.

All user profile information that is shared between the first service provider SP1 and the second service provider SP2 has to be verified by the profile mediator device 5. The user profile UP1, UP2 may be stored in a standard format or can be mapped to a standard format. Examples of standard formats comprise FOAF, SIOC and 3GPP Generic User Profile.

The profile mediator device 5 is arranged to retrieve a policy (set up by the user 4) from the policy server 6. This policy is then applied when exchanging the user profile information between the service providers SP1, SP2. The profile mediator device 5 is further arranged to issue a processing algorithm which comprises both filtering of information and encryption to respective transmitting and receiving parties (service providers SP1, SP2).

In order for the service providers SP1, SP2 to be able to communicate securely with the profile mediator device 5, they each have the earlier mentioned agent 2, 3. All user profile information that is shared among the first service provider SP1 and the second service provider SP2 is verified and protected by these trusted agents 2, 3. It is understood that this can be generalized to multiple service providers, each having a trusted agent. A user profile obtained from another service provider can only be used by the designated service provider. The user profile cannot be further shared with other service providers, without the consent of the user.

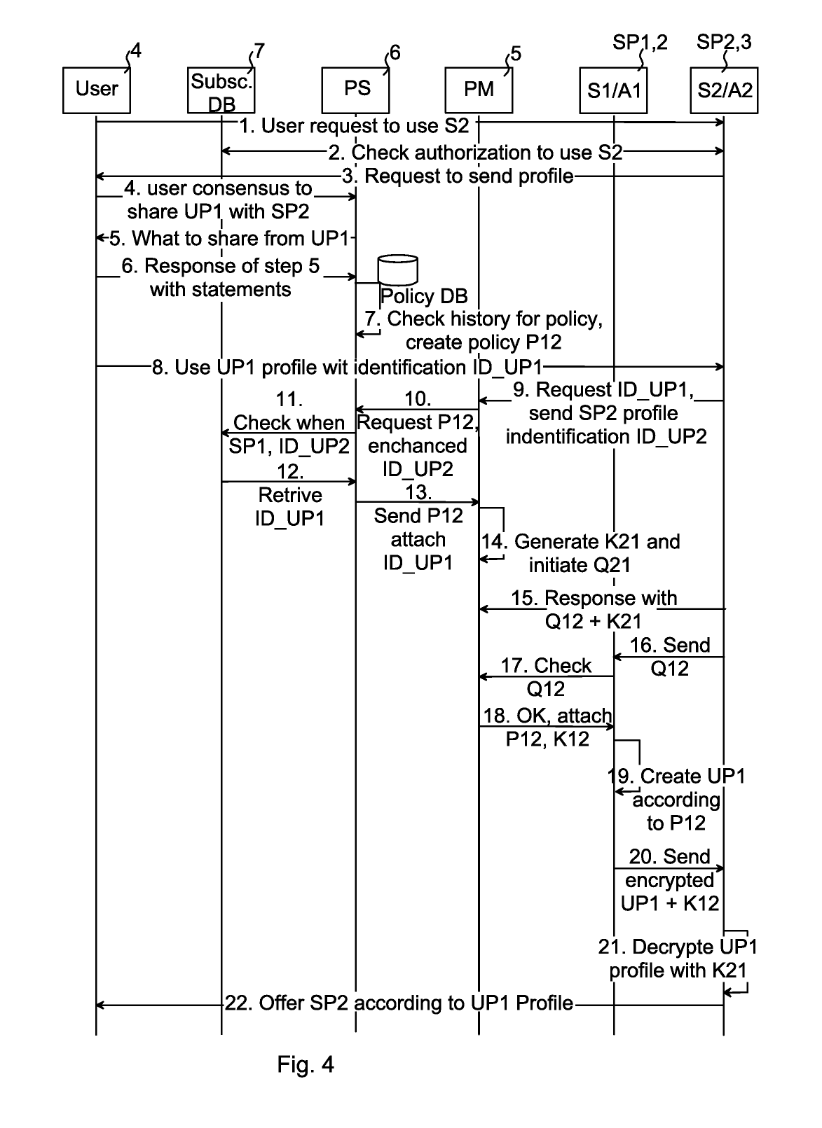

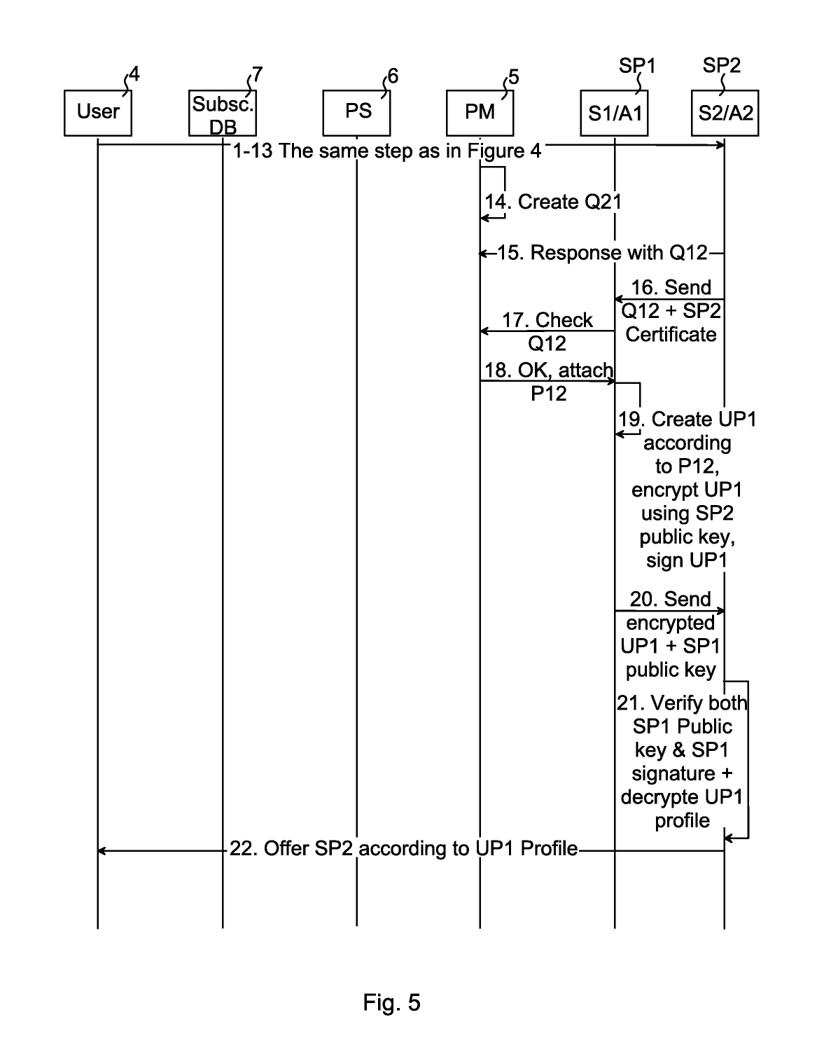

FIG. 4 is a first sequence diagram illustrating exchange of user profiles and communication to this end. When the second service provider SP2 wants the user's 4 user profile UP1 information from the first service provider SP1, the following sequence of communication and actions are performed.

At arrow 1, the user 4 sends a request to the second service provider SP2 to start using services provided by the second service provider SP2.

At arrow 2, the second service provider SP2 checks with subscription data base 7 if the user is authorized to use the service and gets confirmation as to the authorization (if not, the sequence ends here).

At arrow 3, the second service provider SP2 asks the user 4 about her profile/preferences in order to be able to provide best possible service, as described earlier.

At arrow 4, the user 4 sends her consensus to the policy server 6 that the user profile UP1 of the first service provider SP1 can be shared with the second service provider SP2.

At arrow 5, the policy server 6 asks the user 4 about what information in the user profile UP1 of the first service provider SP1 that she allows to be shared with the second service provider SP2.

At arrow 6, the user 4 responses to the request from the policy server 6, the response comprising statements concerning sharing parts of user profile UP1 of the first service provider SP1 with the second service provider SP2.

At arrow 7, the policy server 6 checks in a policy database for previous policies concerning similar requests, i.e. the sharing of the user profile UP1 of the first service provider SP1 with the second service provider SP2. If such previous policy exists, then this is used, otherwise the policy server 6 creates a policy P12 according to the statements the user agreed upon in the previous step. Step 6 may be performed whenever the user 4 wants to change the policy. Then steps 4, 5 and 6 may be performed only at service initialization phase, and for subsequent requests these steps can be omitted, going directly from step 3 to step 7.

At arrow 8, the user 4 then sends a response to the third step (arrow 3) to the second service provider SP2 and includes an identification ID_UP1 of the user profile UP1 of the first service provider SP1.

At arrow 9, the second service provider SP2 sends a request to the profile mediator device 5 to get authorization or secure key to get the user profile UP1 of the first service provider SP1 and attaches an identification ID_UP2 identifying the user profile UP2 that the second service provider SP2 has about the user 4.

At arrow 10, the profile mediator device 5 forwards the request to the policy server 6 including the ID_UP2 identification.

At arrow 11, the policy server 6 checks for policies using the ID_UP2 identification to get the right policy. This step can be optional if the policy server 6 saves all records about subscription identities locally. However, if the policies are more dynamic it is preferred to check with other entities such as subscription database 7 to get the ID_UP1 identification corresponding to the ID_UP2 identification. It is again noted that until now neither the first service provider SP1 nor the second service provider SP2 know the user profile identification of each other.

At arrow 12, the policy server 6 receives a response (externally or internally, as explained in the previous step) providing the ID_UP1 identification of the user profile of the first service provider SP1.

At arrow 13, the policy server 6 sends the created policy P12 and enhanced ID_UP1 identification to the profile mediator device 5. That is, the policy 12 and user identification ID_UP1 of service provider SP1 are sent to the profile mediator device 5, which later cerates the request accordingly.

At arrow 14, the profile mediator device 5 initiates a query related to the user profile sharing request with identification Q12 and generates a secure key K21 for the intended cryptographic algorithm.

At arrow 15, the policy mediator device 5 responses to the step 9 (arrow 9), sending a response to the second service provider SP2 including the Q12 identification, the key K21 and the associated cryptographic algorithm identifier.

At arrow 16, the second service provider SP2 sends a request to the first service provider SP1, including the Q12 identification received in the previous step. The request is asking for the user profile UP1 of the first service provider SP1.

At arrow 17, the first service provider SP1 checks the validity of the query using the Q12 identification.

At arrow 18, the profile mediator device 5 sends a filtering algorithm in response to the previous step (arrow 17). The filtering algorithm is based on policy P12 and key K12 (together with the crypto algorithm identifier). The filtering algorithm shall be used to encrypt the user profile UP1 of the first service provider SP1.

At arrow 19, the first service provider SP1 creates the user profile that corresponds to the P12 policy received at the previous step (arrow 18) and that has the ID_UP1 identification. The first service provider SP1 encrypts the user profile with the key K12, also received at the previous step (arrow 18).

At arrow 20, the first service provider sends encrypted user profile with identification ID_UP1 to the second service provider SP2.

At arrow 21, the second service provider SP2 decrypt the user profile UP1 with key K21 and use it to adapt the service in accordance with the user preferences included in the user profile.

At arrow 22, the customized service is provided to the user 4.

It is noted that if symmetric cryptography is used to protect the user profile, K21 is equal to K12. If needed, another key can be used to provide integrity protection for the user profile. All these keys should be distributed in a secure way from the profile mediator device 5 to the service providers SP1, SP2.

FIG. 5 is a second sequence diagram illustrating exchange of user profiles, describing an alternative embodiment using public key certificate. Steps 1-13 of this embodiment correspond to steps 1-13 of the FIG. 4.

The first service provider SP1 and the second service provider SP2 each have a pair of keys and associated public key certificate. The certificates are issued by the profile mediator device 5, or by a third party (not illustrated) that is trusted by both the first service provider SP1 and the second service provider SP2. The first service provider SP1 and the second service provider SP2 can therefore verify each others public key certificate. In this embodiment, the profile mediator device 5 does not need to generate keys and distribute them to the first service provider SP1 and the second service provider SP2 (arrows 14, 15 and 18 of FIG. 4). Instead, at step 19 (arrow 19) the first service provider SP1 encrypts the user profile UP1 with the second service provider SP2's public key that is contained in the second service provider SP2's certificate. The first service provider SP1 can get the certificate of the second service provider SP2 at step 16 and verify it. Then, still at step 19 (arrow 19), the first service provider SP1 signs the user profile UP1 with its own private key.

At arrow 21, the second service provider SP2 verifies the public key certificate of the first service provider SP1 (which can be obtained at the previous step, arrow 20), uses the contained public key to verify the first service provider SP1's signature and then decrypts the user profile UP1 with its own private key. As an alternative, the first service provider SP1 can generate a fresh symmetric key for profile encryption and use the second service provider SP2's public key to securely transmit the symmetric key to the second service provider SP2.

For services that do not have access to a public key infrastructure, the profile mediator device 5 can keep track of public keys for them and vouch for the correct binding between a service provider and its public key. The profile mediator device 5 stores public keys, or hash of the public keys, of associated service providers. At arrow 15 and 18, the profile mediator device 5 provides the first service provider's SP1 public key (or a hash of it) to the second service provider SP2, and the second service provider's SP2 public key (or a hash of it) to the first service provider SP1. The profile mediator device 5 has to update or revoke stored public keys (or hashes) immediately upon service update/termination or business relation changes, since outdated or compromised private/public keys may give user profile access to unauthorized parties.

In the embodiment of FIG. 5, using public key certificates, not even the profile mediator device 5 can view the content of the user profile. Since the profile mediator device 5 does not know the key that is used to encrypt the user profile, it cannot decrypt the user profile. Thereby, even if the profile mediator device 5 were to be compromised, it could not modify the user profile. Further, the second service provider can be sure that the received user profile UP1 came from the first service provider SP1 by virtue of the public key and certificate being used. In particular, the first service provider SP1 signs the user profile with its private key, which is known only to the first service provider SP1. Moreover, the first service provider SP1 cannot later deny that the user profile UP1 was indeed originated from it.

In the following an implementation example is given. A user uses Company A to get television services at home. He further uses Company B to get television services to his phone. Both service providers, i.e. Company A and Company B, store user profile information such as user logs, ratings, favorites etc. at their respective servers. If Company B (the second service provider) wants to provide improved personalized service to the user by using user information from Company A (the first service provider), then Company B sends a request to the profile mediator device 5 with the user's Company B identification and from which service provider (Company A) it wants information. The profile mediator device 5 contacts the user's policy server 6 to find out which policy applies and what information can be shared. The policy server 6 also looks up the user's identification at Company A. The profile mediator device 5 generates a profile policies processing algorithm in accordance with the policy and sends an identification for the algorithm to Company B.

Company B can then query Company A for user profile information by sending the query identification from the profile mediator device 5. Company A receives the algorithm identification and fetches the algorithm from the profile mediator device 5 to process the user profile information and stored in the file with usage restrictions. Company A and Company B decides on a secure communication channel for transmission of the file. A trusted agent 3 pre-installed at the Company B receives the file containing user profile and guarantees that the restrictions of the policy are followed.

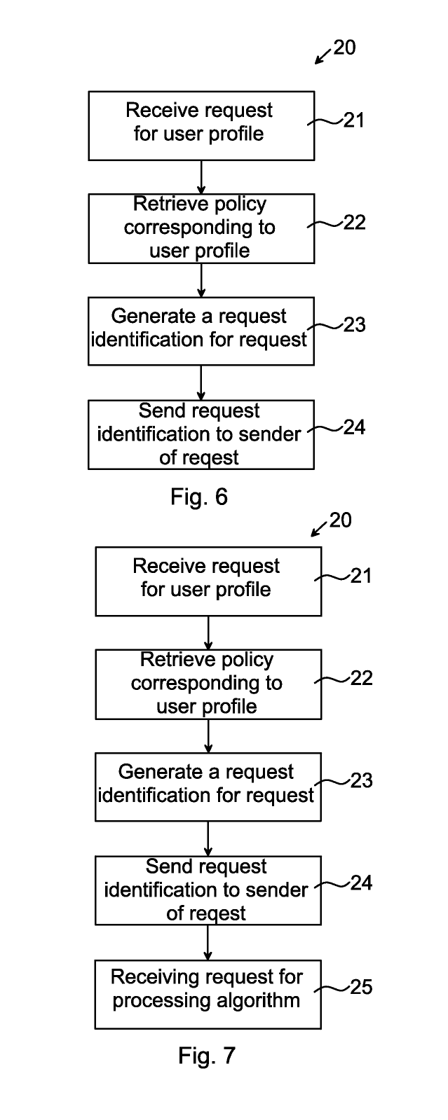

FIG. 6 is a flow chart illustrating a method performed in the profile mediator device 5. The method 20 performed in the profile mediator device 5 for exchanging user profile UP1 of the user between a first service provider SP1 having a first user profile UP1 for the user, and a second service provider SP2, comprises the first step of receiving 21 from the second service provider SP2 a request for the user profile UP1.

The method 20 comprises the second step of retrieving 22 a policy corresponding to the user profile UP1.

The method 20 comprises the third step of generating 23 a request identification Q12 for the request.

The method 20 comprises the fourth step of sending 24 the request identification Q12 to the second service provider SP2 (the sender of the request), the request identification Q12 enabling the first service provider SP1 to exchange the user profile UP1 with the second service provider SP2 in accordance with the policy.

In an embodiment (illustrated in FIG. 7), the method 20 comprises the further step of receiving 25, from the first service provider SP1, a request for a processing algorithm corresponding to the request identification Q12. The processing algorithm comprises filtering user information in accordance with the policy, thus obtaining a filtered user profile UP1′.

The processing algorithm may further comprise encryption keys enabling the first service provider SP1 to encrypt the filtered user profile UP1′.

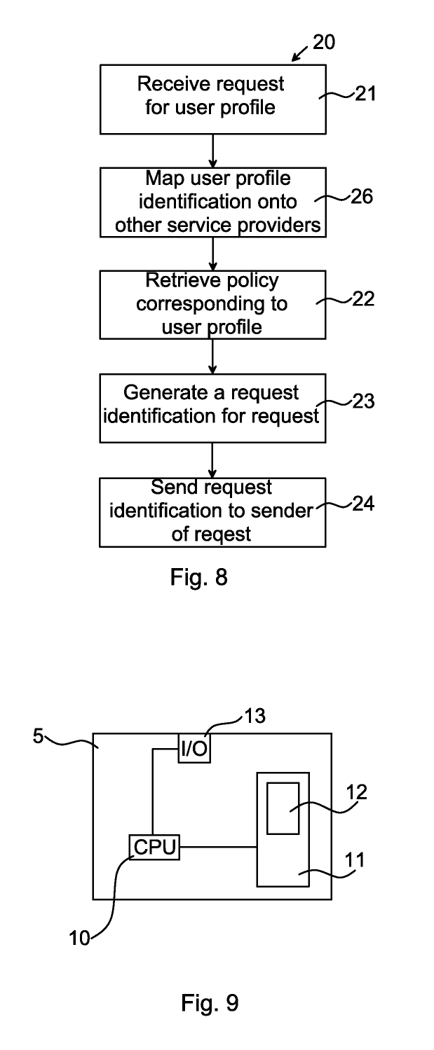

The method 20 may comprise the further step of (illustrated in FIG. 8), upon receiving from the second service provider SP2 the request for user profile UP1, mapping 26 a user profile identification ID_UP2, received with the request, onto services provided to the user by the first service provider SP1.

In an embodiment, the step of retrieving 22 the policy further comprises the sub-step of evaluating the user profile UP1 against the policy.

In an embodiment, the step of retrieving 22 a policy comprises retrieving the policy from a policy server 6, the policy comprising policy rules set by the user.

In an embodiment, the exchanged user profile is an adapted version of the user profile UP1 of the first service provider SP1, comprising user information conforming to the policy.

In an embodiment, the request for the user profile UP1 is received from a second trusted agent 3, such as a software agent, of the second service provider SP2.

FIG. 9 illustrates the profile mediator device 5. The profile mediator device 5 comprises a controller 10 arranged to perform the method as described earlier. The controller 10 may be any suitable central processing unit (CPU), microcontroller, digital signal processor (DSP), etc., capable of executing software instructions stored in a computer program product 11 e.g. in the form of a memory.

The profile mediator device 5 comprises an input/output device 13 for communicating with other devices, for example receiving requests and sending request identifications.

The invention also encompasses the computer program 12 for the profile mediator device 5 for enabling exchange of the user profile UP1. The computer program 12 comprises computer program code which, when run on the profile mediator device 5, causes the profile mediator device 5 to perform the steps of the method described earlier.

The invention also encompasses the computer program product 11 comprising the computer program 12 and a computer readable means on which the computer program 12 is stored. The computer program product 11 can be a memory or any combination of read and write memory (RAM) and read only memory (ROM). The memory also comprises persistent storage, which, for example, can be any single one or combination of magnetic memory, optical memory, or solid state memory or even remotely mounted memory.

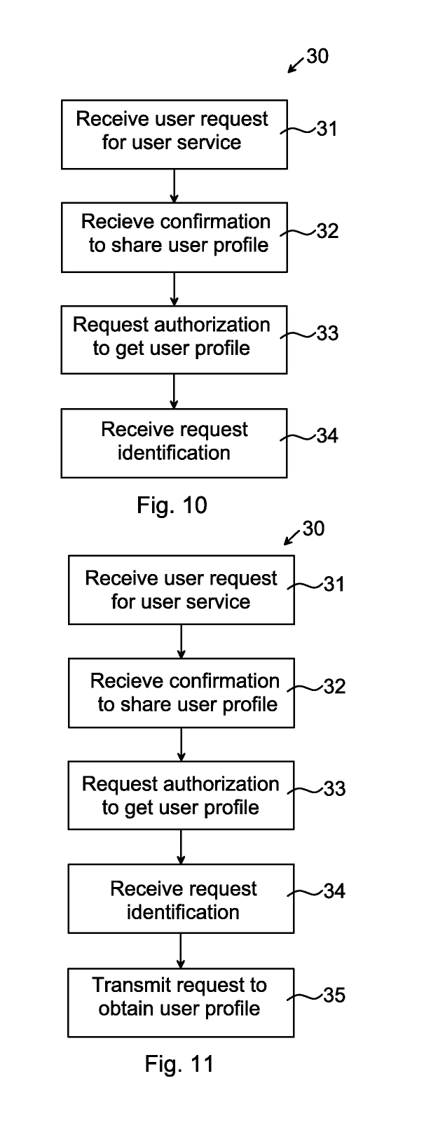

FIG. 10 is a flow chart illustrating a method performed in an agent of a second service provider for exchanging user profile. The method 30 is performed in the agent 3 of the second service provider SP2. The method 30 comprises the first step of receiving 31 a user request to use a service provided by the second service provider SP2.

The method 30 comprises the second step of receiving 32, from the user, a user profile identification ID_UP1 confirming consensus to share with the second service provider SP2 a user profile UP1 from the first service provider SP1 in accordance with a policy.

The method 30 comprises the third step of requesting 33 from a profile mediator device 5 authorization to get the user profile UP1 of the first service provider SP1 identified by the user profile identification ID_UP1.

The method 30 comprises the fourth step of receiving 34 from the profile mediator device 5 a request identification Q12, the request identification Q12 enabling the first service provider SP1 to exchange the user profile UP1 with the second service provider SP2.

In an embodiment, the method 30 comprises the further step of (illustrated in FIG. 11) transmitting 35 to the first service provider SP1 a request for obtaining the user profile UP1, the request comprising the request identification Q12.

In an embodiment, the method 30 comprises the steps of receiving in response from the first service provider SP1 a filtering of user profile UP1 encrypted and decrypting the filtering of user profile UP1. The decryption may be performed by means of a public key or by means of decryption algorithms, e.g. a symmetric key, received from the profile mediator device 5.

In the above embodiments, the filtering of user profile UP1 has been processed by a processing algorithm corresponding to the request identification Q12, the processing algorithm comprising filtering user information in accordance with the policy, thus obtaining a filtered user profile UP1′.

In an embodiment, the method 30 comprises the step of, upon receiving the user request to use a service, checking authorization of the user to use services of the second service provider SP2.

In an embodiment, the step of receiving 32 consensuses to share a user profile UP1 is received as a response to an inquiry sent to the user about user preferences.

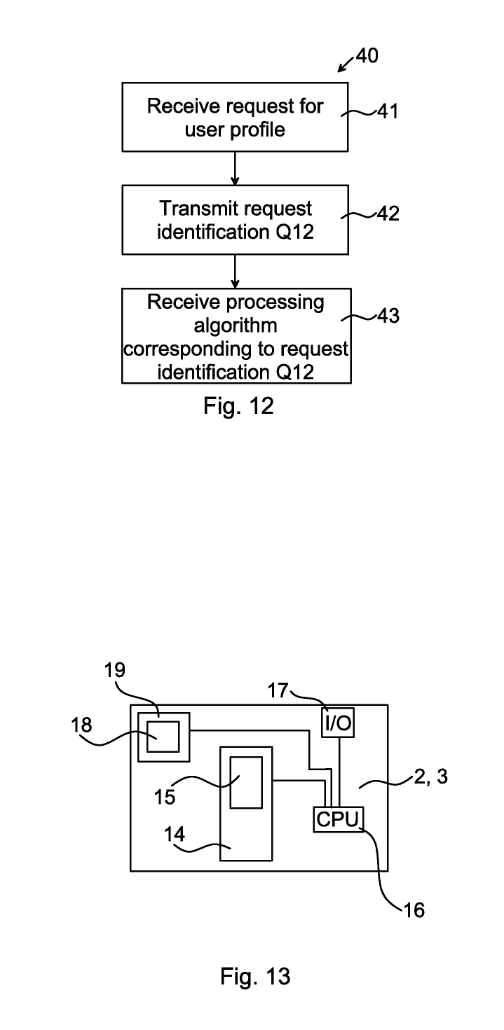

FIG. 12 is a flow chart illustrating a method performed in the agent 2 of the first service provider SP1 for exchanging a filtering of the user profile UP1 between the first service provider SP1 and the second service provider SP2. The method 40 comprises the first step of receiving 41 from the second service provider SP2 a request for obtaining the user profile UP1. The request comprises a request identification Q12.

The method 40 comprises the second step transmitting 42 to the profile mediator device 5 the request identification Q12.

The method 40 comprises the third step of receiving 43 a processing algorithm corresponding to the request identification Q12. The processing algorithm comprises filtering user information in accordance with a policy, thus obtaining a filtered user profile UP1′.

The method 40 may comprise the further step of creating the filtered user profile UP1′ in accordance with the processing algorithm and encrypting the filtered user profile UP1′. The method 40 may then comprise the further step of transmitting to the second service provider SP2 the encrypted filtered user profile UP1′.

FIG. 13 illustrates an agent 2, 3 for exchanging user profiles. The agent comprises a controller 16 arranged to perform the methods as described earlier as being performed in an agent. The controller 16 may be any suitable central processing unit (CPU), microcontroller, digital signal processor (DSP), etc., capable of executing software instructions stored in a computer program product 14, 19 e.g. in the form of a memory.

The agent 2, 3 comprises an input/output device 17 for communicating with other devices, for example receiving requests and sending request identifications.

The invention also encompasses the computer program 15 for the agent 3 for exchanging a user profile UP1 between the first service provider SP1 and a second service provider SP2. The computer program 15 comprising computer program code which, when run on the agent 3, causes the agent 3 to perform the steps of the method described earlier.

The invention also encompasses the computer program product 14 comprising a computer program 15 and a computer readable means on which the computer program 15 is stored. The computer program product 14 can be a memory or any combination of read and write memory (RAM) and read only memory (ROM). The memory also comprises persistent storage, which, for example, can be any single one or combination of magnetic memory, optical memory, or solid state memory or even remotely mounted memory.

The invention also encompasses a computer program 18 for the agent 2 for exchanging a user profile UP1 between a first service provider SP1 and the second service provider SP2. The computer program 18 comprises computer program code which, when run on the agent 2, causes the agent 2 to perform the steps of the method descried earlier.

The invention also encompasses the computer program product 19 comprising a computer program 18 as above and a computer readable means on which the computer program 18 is stored.

The computer program product 19 can be a memory or any combination of read and write memory (RAM) and read only memory (ROM). The memory also comprises persistent storage, which, for example, can be any single one or combination of magnetic memory, optical memory, or solid state memory or even remotely mounted memory.

In FIG. 13, the agent is denoted by reference numerals 2 and 3. Typically, the agent 2 of the first service provider SP1 described earlier also comprises means to act as the agent 3 of the second service provider SP2. That is, although the first agent 2 is for clarity described earlier as the agent receiving a request from a second service provider for a user profile that it has, it may also request from another service provider, the other service provider's user profile for a certain user. The same is true for the agent 3 of the second service provider SP2.

The invention, as described in various embodiments, enables the trusted sharing of user information between service providers while at the same time protecting the user privacy. Further, a common framework for user profile sharing is provided, which could serve as basis for standardization. Moreover, the user is provided with total control over policies in accordance with which user data is to be shared. Further still, there is no need to save a user profile enabling minimization of memory requirements.

The mentioned and described embodiments are given only as examples and should not be construed as limiting for the present invention. The invention has been described in connection with what is presently considered to be most practical and preferred embodiments. However, it is to be understood that the invention is not to be limited to the disclosed embodiments, but on the contrary, is intended to cover various modifications, equivalent arrangements, uses, objectives and functions. Therefore the invention is only to be limited by the following claims. Furthermore, the invention is not limited to the specific order in which steps are presented in the method claims.

1-27. (canceled)

28. A method performed by a profile mediator device for exchanging a user profile of a user between a first service provider having the user profile for the user, and a second service provider, the method comprising:
receiving from a server of the second service provider a request for the user profile;
retrieving a policy corresponding to the user profile;
generating a request identification for the request; and
sending the request identification to the server of the second service provider, the request identification enabling the first service provider to exchange the user profile with the second service provider in accordance with the policy.

29. The method as claimed in claim 28, further comprising receiving, from a server of the first service provider, a request for a processing algorithm corresponding to the request identification, the processing algorithm comprising filtering user information from the user profile in accordance with the policy, to obtain a filtered user profile.

30. The method as claimed in claim 29, wherein the processing algorithm further comprises encryption keys enabling the server of the first service provider to encrypt the filtered user profile.

31. The method as claimed in claim 28, further comprising, upon receiving from the server of the second service provider the request for the user profile, mapping a user identification received with the request onto services provided to the user by the first service provider.

32. The method as claimed in claim 31, wherein the step of retrieving the policy corresponding to the user profile further comprises the sub-step of evaluating the user profile against the policy.

33. The method as claimed in claim 28, wherein the step of retrieving the policy comprises retrieving the policy from a policy server, the policy comprising policy rules set by the user.

34. The method as claimed in claim 28, wherein the user profile as exchanged between the first service provider and the second service provider is an adapted version of the user profile of the user at the first service provider, said adapted version comprising user information conforming to the policy.

35. The method as claimed in claim 28, wherein the request for the user profile is received from a second trusted agent of the server of the second service provider.

36. A profile mediator device for enabling the exchange of a user profile of a user between a first service provider having the user profile and a second service provider, the profile mediator device comprising a controller arranged to:
receive, via an input/output device, from a server of the second service provider a request for the user profile;
retrieve, via the input/output device, a policy corresponding to the user profile, generate a request identification for the request; and
send, via the input/output device, the request identification to the server of the second service provider, the request identification enabling a server of the first service provider to exchange the user profile with the server of the second service provider.

37. A computer-readable medium storing a computer program for a profile mediator device, for enabling exchange of a user profile of a user between a first service provider having the user profile and a second service provider, the computer program comprising computer program code which, when executed on a profile mediator device, configures the profile mediator device to:
receive from a server of the second service provider a request for the user profile;
retrieve a policy corresponding to the user profile;
generate a request identification for the request; and
send the request identification to the server of the second service provider, the request identification enabling a server of the first service provider to exchange the user profile with the server of the second service provider.

38. A method performed by an agent of a server of a second service provider, for exchanging a user profile of a user between a first service provider having the user profile and the second service provider, the method comprising:
receiving a request for the user to use a service provided by the second service provider;
receiving, from the user, a user profile identification confirming consensus to share with the second service provider the user profile of the user from the first service provider in accordance with a policy;
requesting from a profile mediator device authorization to get the user profile from the first service provider, as identified by the user profile identification;
receiving from the profile mediator device a request identification, the request identification enabling a server of the first service provider to exchange the user profile with the server of the second service provider.

39. The method as claimed in claim 38, further comprising transmitting to the server of the first service provider a request for obtaining the user profile, the request comprising the request identification.

40. The method as claimed in claim 39, further comprising receiving in response from the server of the first service provider an encrypted filtered user profile corresponding to the user profile of the user, and decrypting the encrypted filtered user profile.

41. The method as claimed in claim 40, wherein the decryption is performed using a public key or a symmetric key received from the profile mediator device.

42. The method as claimed in claim 40, wherein the filtered user profile has been processed by a processing algorithm corresponding to the request identification, the processing algorithm comprising filtering user information from the user profile of the user in accordance with the policy, to thereby obtain the filtered user profile.

43. The method as claimed in claim 38, further comprising, upon receiving the request to use the service, checking authorization of the user to use services of the second service provider.

44. The method as claimed in claim 38, wherein receiving the consensus to share the user profile is received as a response to an inquiry sent to the user about user preferences.

45. An agent for a server of a second service provider for exchanging a user profile of a user between a first service provider having the user profile and the second service provider, said agent comprising a controller arranged to:
receive, via an input/out device, a request for the user to use a service provided by the second service provider;
receive, via the input/out device, from the user, a user profile identification confirming consensus to share the user profile from the first service provider with the second service provider, in accordance with a policy;
request from a profile mediator device, via the input/out device, authorization to get the user profile of the first service provider, as identified by the user profile identification; and
receive from the profile mediator device, via the input/out device, a request identification, the request identification enabling a server of the first service provider to exchange the user profile with the server of the second service provider.

46. A computer-readable medium storing a computer program for an agent of a server of a second service provider, for exchanging a user profile of a user between a first service provider having the user profile and the second service provider, the computer program comprising computer program code which, when run on the agent, configures the agent to:
receive a request for the user to use a service provided by the second service provider,
receiving, from the user, a user identification confirming consensus to share with the second service provider a user profile of the first service provider;
requesting from a profile mediator device authorization to get the user profile from the first service provider, as identified by the user identification; and
receiving from the profile mediator device a request identification, the request identification enabling a server of the first service provider to exchange the user profile with the server of the second service provider.

47. A method performed in an agent of a server of a first service provider for exchanging filtered user profile between the first service provider and a second service provider, the method comprising:
receiving from a server of the second service provider a request for obtaining a user profile of a user, the request comprising a request identification;
transmitting to a profile mediator device the request identification and
receiving a processing algorithm corresponding to the request identification, the processing algorithm for filtering of user information from the user profile in accordance with a policy, for use in obtaining the filtered user profile.

48. The method as claimed in claim 47, comprising the further step of creating the filtered user profile in accordance with the processing algorithm and encrypting the filtered user profile.

49. The method as claimed in claim 48, comprising the further step of transmitting to the server of the second service provider the encrypted filtered user profile.

50. An agent for a server of a first service provider for exchanging a filtered user profile between the first service provider and a second service provider, the agent comprising a controller arranged to:
receive, via an input/output device, from a server of the second service provider a request for obtaining a user profile of a user, the request comprising a request identification;
transmitting, via the input/output device, to a profile mediator device the request identification; and
receiving, via the input/output device, a processing algorithm corresponding to the request identification, the processing algorithm for use in filtering user information in the user profile in accordance with a policy, to thereby obtain the filtered user profile for exchanging.

51. A computer-readable medium storing computer program for an agent of a server of a first service provider for exchanging a filtered user profile between the first service provider and a second service provider, the computer program comprising computer program code which, when run on the agent, configures the agent to:
receive from a server of the second service provider a request for obtaining a user profile of a user, the request comprising a request identification;
transmit to a profile mediator device the request identification; and
receive a processing algorithm corresponding to the request identification, the processing algorithm for filtering user information in the user profile in accordance with a policy, to thereby obtain the filtered user profile for exchanging.
